(19) United States
(12) Patent Application Publication
(10) Pub. No.: US 2025/0184993 A1
(43) Pub. Date: Jun. 5, 2025

(54) SCHEDULING FOR NON-TERRESTRIAL NETWORKS

(71) Applicant: QUALCOMM Incorporated, San Diego, CA (US)

(72) Inventors: Le LIU, San Jose, CA (US); Alberto RICO ALVARINO, San Diego, CA (US)

(21) Appl. No.: 18/962,012

(22) Filed: Nov. 27, 2024

Related U.S. Application Data
(60) Provisional application No. 63/605,319, filed on Dec. 1, 2023.

(51) Int. Cl. H04W 72/1263; H04L 5/16; H04W 56/00; H04W 72/563

(52) U.S. Cl. CPC H04W 72/1263; H04L 5/16; H04W 56/0045; H04W 72/563

(57) ABSTRACT

Various aspects of the present disclosure generally relate to wireless communication. In some aspects, a user equipment (UE) may receive, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The UE may communicate, in the non-terrestrial network, with a network node using at least one of the uplink resource or the downlink resource in accordance with the collision avoidance rule or the collision handling rule. Numerous other aspects are described.

This Patent Application claims priority to U.S. Provisional Patent Application No. 63/605,319, filed on Dec. 1, 2023, entitled “SCHEDULING FOR NON-TERRESTRIAL NETWORKS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for scheduling for non-terrestrial networks (NTNs).

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The method may include communicating, in the non-terrestrial network, with a network node using at least one of the uplink resource or the downlink resource in accordance with the collision avoidance rule or the collision handling rule.

Some aspects described herein relate to a method of wireless communication performed by a network node. The method may include transmitting, for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The method may include communicating, in the non-terrestrial network, with the UE using at least one of the uplink resource or the downlink resource in accordance with the collision avoidance rule or the collision handling rule.

Some aspects described herein relate to a UE for wireless communication. The UE may include one or more memories and one or more processors coupled to the one or more memories. The one or more processors may be configured to receive, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The one or more processors may be configured to communicate, in the non-terrestrial network, with a network node using at least one of the uplink resource or the downlink resource in accordance with the collision avoidance rule or the collision handling rule.

Some aspects described herein relate to a network node for wireless communication. The network node may include one or more memories and one or more processors coupled to the one or more memories. The one or more processors may be configured to transmit, for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The one or more processors may be configured to communicate, in the non-terrestrial network, with the UE using at least one of the uplink resource or the downlink resource in accordance with the collision avoidance rule or the collision handling rule.

Some aspects described herein relate to a non-transitory computer-readable medium that stores a set of instructions for wireless communication by a UE. The set of instructions, when executed by one or more processors of the UE, may cause the UE to receive, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The set of instructions, when executed by one or more processors of the UE, may cause the UE to communicate, in the non-terrestrial network, with a network node using at least one of the uplink resource or the downlink resource in accordance with the collision avoidance rule or the collision handling rule.

Some aspects described herein relate to a non-transitory computer-readable medium that stores a set of instructions for wireless communication by a network node. The set of instructions, when executed by one or more processors of the network node, may cause the network node to transmit, for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The set of instructions, when executed by one or more processors of the network node, may cause the network node to communicate, in the non-terrestrial network, with the UE using at least one of the uplink resource or the downlink resource in accordance with the collision avoidance rule or the collision handling rule.

Some aspects described herein relate to an apparatus for wireless communication. The apparatus may include means for receiving, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The apparatus may include means for communicating, in the non-terrestrial network, with a network node using at least one of the uplink resource or the downlink resource in accordance with the collision avoidance rule or the collision handling rule.

Some aspects described herein relate to an apparatus for wireless communication. The apparatus may include means for transmitting, for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The apparatus may include means for communicating, in the non-terrestrial network, with the UE using at least one of the uplink resource or the downlink resource in accordance with the collision avoidance rule or the collision handling rule.

In some implementations, the collision avoidance rule or the collision handling rule is associated with a prioritization of a synchronization signal block in the downlink resource relative to an uplink transmission in at least part of the uplink resource, an overlap is configured to occur in at least one symbol during a reserved time associated with the downlink resource of the synchronization signal block.

In some implementations, the collision avoidance rule or the collision handling rule is associated with a reserved time for a downlink resource of a synchronization signal block, the reserved time not being counted for the uplink resource.

In some implementations, the collision avoidance rule or the collision handling rule is associated with a prioritization of a synchronization signal block in the downlink resource relative to at least part of the uplink resource, an overlap is configured to occur in at least one symbol or is configured to occur during a switching time in an absence of signaling indicating a reserved time.

In some implementations, the collision avoidance rule or the collision handling rule is associated with a prioritization of the uplink resource relative to at least part of the downlink resource of a synchronization signal block, an overlap is configured to occur in at least one symbol or during a switching time in an absence of the signaling indicating a reserved time.

In some implementations, the collision avoidance rule or the collision handling rule is associated with a prioritization of a downlink resource with a configured grant or a dynamic grant relative to at least part of the uplink resource with a configured grant or a dynamic grant, an overlap is configured to occur in at least one symbol during a reserved time associated with the downlink resource with the configured grant or the dynamic grant.

In some implementations, the collision avoidance rule or the collision handling rule is associated with a reserved time corresponding to a downlink resource with a configured grant or a dynamic grant, the reserved time not being counted for the uplink resource with the configured grant or the dynamic grant.

In some implementations, the collision avoidance rule or the collision handling rule is associated with a prioritization of a downlink resource with a configured grant, a dynamic grant relative to at least part of the uplink resource with a configured grant, or a dynamic grant that overlaps with at least one symbol, the prioritization is related to a switching time in an absence of signaling indicating a reserved time.

In some implementations, the collision avoidance rule or the collision handling rule is associated with a prioritization of the uplink resource with a configured grant or a dynamic grant relative to at least part of a downlink resource with a configured grant or a dynamic grant, the prioritization is related to an overlap of at least one symbol or is related to a switching time in an absence of signaling indicating a reserved time.

In some implementations, the collision handling rule is associated with a prioritization of downlink control channel monitoring of the downlink resource relative to an uplink resource with a configured grant if overlapping at least one symbol during a reserved time associated with downlink control channel monitoring of the downlink resource.

In some implementations, the collision avoidance rule or the collision handling rule is associated with a reserved time corresponding to downlink control channel monitoring of the downlink resource, and the reserved time is not counted for the uplink resource with a configured grant.

In some implementations, the collision avoidance rule or the collision handling rule is associated with a prioritization of downlink control channel monitoring of the downlink resource relative to at least part of the uplink resource with a configured grant, an overlap is configured in at least one symbol or during a switching time in an absence of signaling indicating a reserved time.

In some implementations, the collision avoidance rule or the collision handling rule is associated with a prioritization of an uplink resource with a configured grant relative to at least part of a downlink control channel monitoring of the downlink resource, an overlap is configured in at least one symbol or during a switching time in an absence of signaling indicating a reserved time.

In some implementations, the collision avoidance rule or the collision handling rule is based at least in part on whether a timing advance is estimated in connection with a UE reported timing advance or location.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a regenerative satellite deployment and an example of a transparent satellite deployment in a non-terrestrial network.

FIG. 5 is a diagram illustrating an example of a synchronization signal hierarchy, in accordance with the present disclosure.

FIG. 6 is a diagram illustrating an example of downlink and uplink transmissions between a network node and a UE in a wireless network, in accordance with the present disclosure.

FIGS. 7A-7D are diagrams illustrating an example associated with scheduling for NTNs, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node and a user equipment (UE) may use one or more timing parameters to avoid interference between uplink communications and downlink communications. For example, a network node may schedule an uplink transmission for a slot n_{UL}, which may be offset from another slot n_{DL} in which a downlink transmission is scheduled. An offset parameter, such as a cell-specific offset parameter or a UE-specific offset parameter among other examples, may be introduced to accommodate a propagation delay between transmission of a communication and reception of the communication or a tuning delay between tuning from transmission to reception, among other examples. For example, in a non-terrestrial network (NTN), the network node may schedule, at a network node side, n_{UL}=n+K+K_{offset}, where n represents a slot in which a downlink transmission (e.g., a physical downlink control channel (PDCCH)) occurs, K is a general offset parameter for network node and UE synchronization, and K_{offset} represents a scheduling offset for NTNs. The network node may configure a value for K_{offset} based on a cell-specific offset parameter (K_{cell,offset}) and a UE-specific offset parameter (K_{UE,offset}). By including a K_{offset} value for NTNs (in addition to the general K that is used for non-NTNs as well), the network node accounts for larger round-trip times (RTTs) associated with NTNs (relative to non-NTNs). The network node may signal a value for K_{cell,offset} in a system information block (SIB) and can configure a value for K_{UE,offset} on a per-UE basis using a medium access control (MAC) control element (CE) (MAC-CE) for connected mode UEs.

Similarly, in the NTN, the network node may schedule, at a UE side, transmission of an uplink communication at a timing n_{UL,UE}=n_{UL}−T_{TA}, where n_{UL,UE} represents a time, for the UE, at which the uplink communication is transmitted (in contrast to n_{UL}, which is the time at the network node at which the uplink communication is transmitted) and T_{TA} represents a timing advance value. The timing advance value may be based at least in part on multiple factors, such as a network-controlled timing advance value, a UE self-estimated timing advance value, or a timing advance offset, among other examples, as described in more detail herein.

Some UEs may be associated with different capabilities. For example, a first type of UE may be configured for full-duplex (FD) communications. A second type of UE, which may be referred to as a UE with half-duplex (HD) communications. For example, the UE may be a reduced capability (RedCap) UE with HD in a paired spectrum deployment. An HD UE, operating in an HD frequency division duplex (FDD) network, may have a set of guard periods or non-zero switching time (e.g., HD guard subframe, guard symbol, or less than a symbol) in which the UE is configured to switch between a transmission mode and a reception mode. For example, the UE may not receive a downlink subframe immediately preceding or following an uplink subframe of the UE. In an NTN system, the UE applies a relatively large timing advance for uplink transmission due to a long round trip time (RTT) delay between a satellite and the UE. For example, the RTT delay may be in a range of approximately 11 milliseconds (ms) to 35 ms for low-Earth orbit (LEO) and in a range of approximately 245 ms to 285 ms for geostationary Earth orbit (GEO) (including a 5 ms network latency, which is substantially larger than occurs in a terrestrial network (TN)). However, when a network node does not have information identifying an uplink timing advance of the UE, the network node may not be able to account for potential overlapping time including the guard periods when scheduling downlink and uplink communications. Accordingly, the network node and UE may experience communication interruptions when a lack of scheduling synchronization results in transmission of a downlink communication during a period in which the UE is transmitting an uplink communication.

Various aspects relate generally to scheduling for NTNs. Some aspects more specifically relate to a set of rules, such as a collision avoidance rule or a collision resolution rule, for handling HD operation in an NTN. In some aspects, a UE may receive information identifying a timing configuration relating to a collision avoidance rule, a collision resolution rule, or a timing offset value associated therewith, among other examples. In this case, the UE may communicate (e.g., on an uplink by transmitting or on a downlink by receiving) with a network node (e.g., an NTN network node) in accordance with the collision avoidance rule or the collision handling rule. The timing configuration may include one or more rules for handling conflicting transmissions or receptions, such as collision avoidance rule, a collision handling rule, or a timing offset. For example, the UE may receive unicast radio resource control (RRC) signaling identifying a reserved time and may apply a rule for handling one or more transmissions that overlap with the reserved time as described herein. The RRC signaling may indicate a start time of the reserved time and/or an end time of the reserved time. The UE may determine the reserved time based on the RRC signaling, a timing advance value, or another parameter, as described in more detail herein. The UE and the network node may use a collision avoidance rule to determine timing to attempt to avoid a collision between an uplink transmission and a downlink transmission (or a guard period). Additionally, or alternatively, the UE and the network node may use a collision resolution rule to prioritize a communication in a collision scenario where the communication collides with (e.g., schedules and/or occurs concurrently with) another communication.

Particular aspects of the subject matter described in this disclosure can be implemented to realize one or more of the following potential advantages. In some examples, by using a timing configuration, a collision avoidance rule, a collision resolution rule, and/or a prioritization, the described techniques can be used to maintain synchronization between a network node and a UE. Additionally, or alternatively, the described techniques can be used to avoid dropped communications between a UE and a network node. Additionally, or alternatively, the described techniques can be used to ensure that higher priority communications are not dropped (and that lower priority communications are dropped instead) in collision scenarios.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

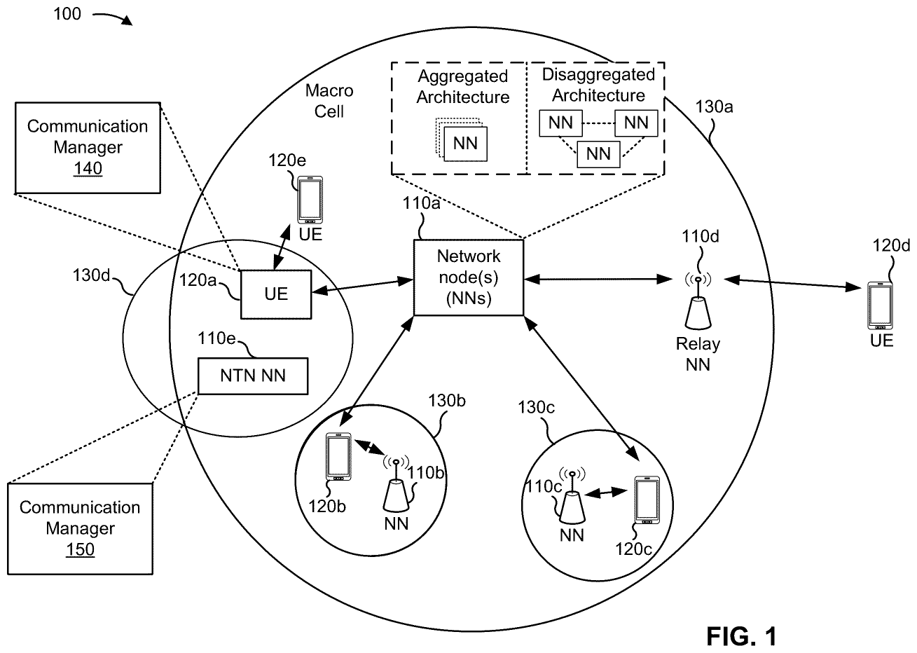

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some examples, a UE 120 may operate in a non-terrestrial network (NTN). For example, the UE 120a may operate in an NTN cell 130d of the network node 110e, which may be providing an NTN. In some aspects, a network node may serve different UEs of different categories and/or different UEs that support different capabilities. For example, the network node 110 may serve a first category of UEs 120 that have a less advanced capability (e.g., a lower capability and/or a reduced capability) and a second category of UEs 120 that have a more advanced capability (e.g., a higher capability). A UE 120 of the first category may have a reduced feature set compared to UEs of the second category, and may be referred to as a reduced capability (RedCap) UE, a low tier UE, and/or an NR-Lite UE, among other examples. A UE 120 of the first category may be, for example, an MTC UE, an eMTC UE, and/or an IoT UE. A UE 120 of the second category may have an advanced feature set compared to UEs 120 of the first category, and may be referred to as a baseline UE, a high tier UE, an NR UE, and/or a premium UE, among other examples. In some aspects, a UE 120 of the first category has capabilities that satisfy requirements of a first (earlier) wireless communication standard but not a second (later) wireless communication standard, while a UE 120 of the second category has capabilities that satisfy requirements of the second (later) wireless communication standard (and also the first wireless communication standard, in some cases).

For example, UEs 120 of the first category may support a lower maximum modulation and coding scheme (MCS) than UEs 120 of the second category (e.g., quadrature phase shift keying (QPSK) or the like as compared to 256-quadrature amplitude modulation (QAM) or the like), may support a lower maximum transmit power than UEs 120 of the second category, may have a less advanced beamforming capability than UEs 120 of the second category (e.g., may not be capable of forming as many beams as UEs 120 of the second category), may require a longer processing time than UEs 120 of the second category, may include less hardware than UEs 120 of the second category (e.g., fewer antennas, fewer transmit antennas, and/or fewer receive antennas), and/or may not be capable of communicating on as wide of a maximum bandwidth part as UEs 120 of the second category, among other examples. Additionally, or alternatively, UEs 120 of the second category may be capable of communicating using a shortened transmission time interval (TTI) (e.g., a slot length of 1 ms or less, 0.5 ms, 0.25 ms, 0.125 ms, 0.0625 ms, or the like, depending on a sub-carrier spacing), and UEs 120 of the first category may not be capable of communicating using the shortened TTI. Additionally, or alternatively, UEs 120 of the first category may be half-duplex (HD) UEs and UEs 120 of the second category may be full-duplex (FD) UEs. In some examples, a UE 120 may transition between categories to, for example, alter a power consumption of the UE 120. For example, a UE 120 may switch from a first mode in which the UE 120 is an HD UE to a second mode in which the UE 120 is an FD UE.

In some aspects, the UE 120 may include a communication manager 140. As described in more detail elsewhere herein, the communication manager 140 may receive, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter; and communicate, in the non-terrestrial network, with a network node using at least one of the uplink resource or the downlink resource in accordance with the collision avoidance rule or the collision handling rule. Additionally, or alternatively, the communication manager 140 may perform one or more other operations described herein.

In some aspects, the network node 110 may include a communication manager 150. As described in more detail elsewhere herein, the communication manager 150 may transmit, for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter; and communicate, in the non-terrestrial network, with the UE using at least one of the uplink resource or the downlink resource in accordance with the collision avoidance rule or the collision handling rule. Additionally, or alternatively, the communication manager 150 may perform one or more other operations described herein.

As indicated above, FIG. 1 is provided as an example. Other examples may differ from what is described with regard to FIG. 1.

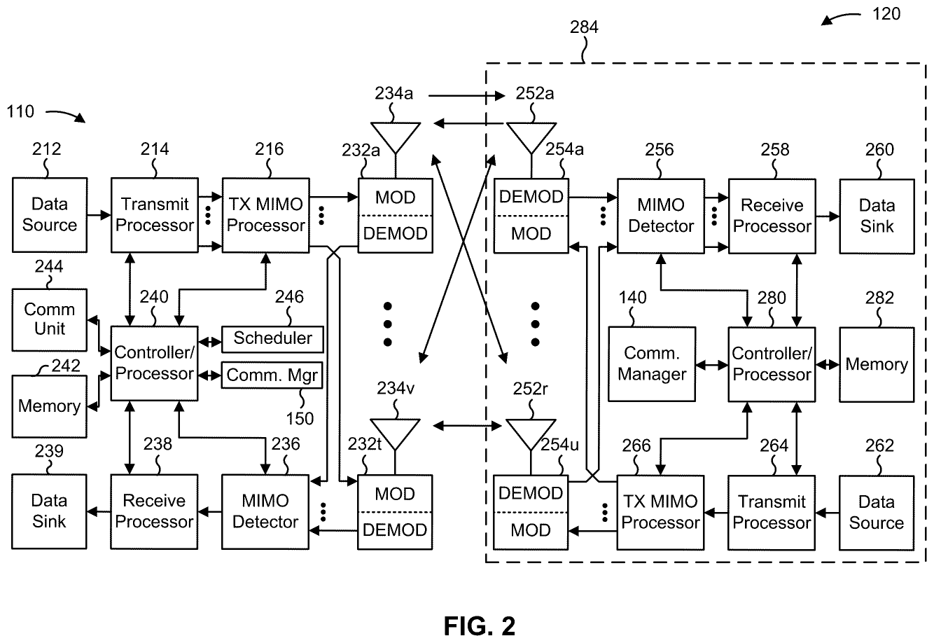

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream May be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the UE 120 includes means for receiving (e.g., using antenna 252, modem 254, transmit processor 264, TX MIMO processor 266, controller/processor 280, or memory 282), for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter; and/or means for communicating (e.g., using antenna 252, modem 254, MIMO detector 256, receive processor 258, transmit processor 264, TX MIMO processor 266, controller/processor 280, or memory 282), in the non-terrestrial network, with a network node using at least one of the uplink resource or the downlink resource in accordance with the collision avoidance rule or the collision handling rule. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting (e.g., using transmit processor 214, TX MIMO processor 216, modem 232, antenna 234, controller/processor 240, memory 242), for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter; and/or means for communicating (e.g., using transmit processor 214, TX MIMO processor 216, modem 232, antenna 234, MIMO detector 236, receive processor 238, controller/processor 240, memory 242), in the non-terrestrial network, with the UE using at least one of the uplink resource or the downlink resource in accordance with the collision avoidance rule or the collision handling rule. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

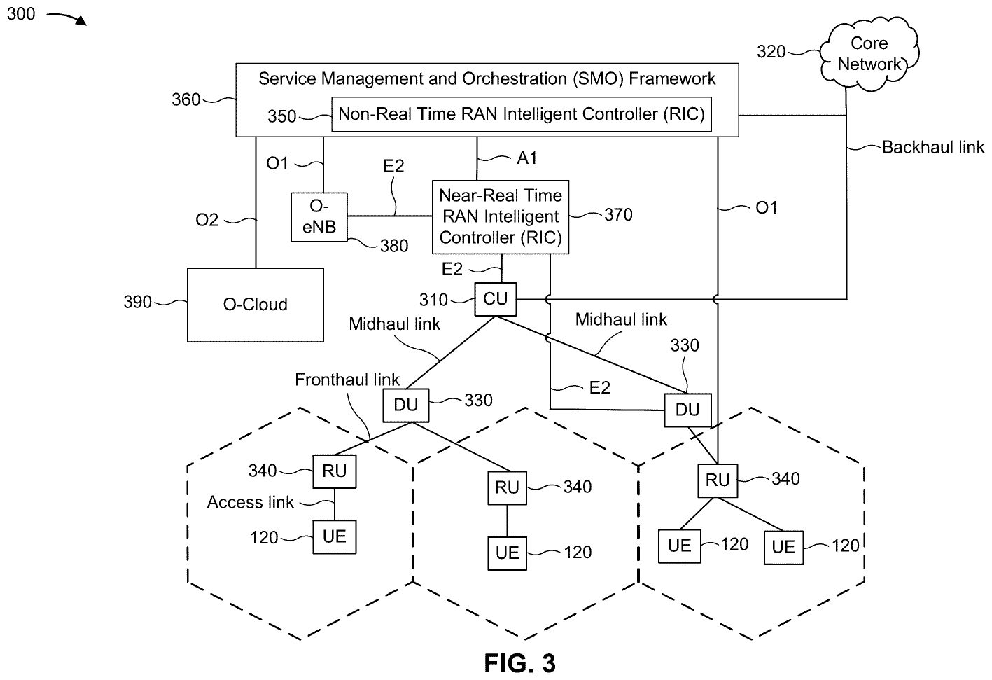

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

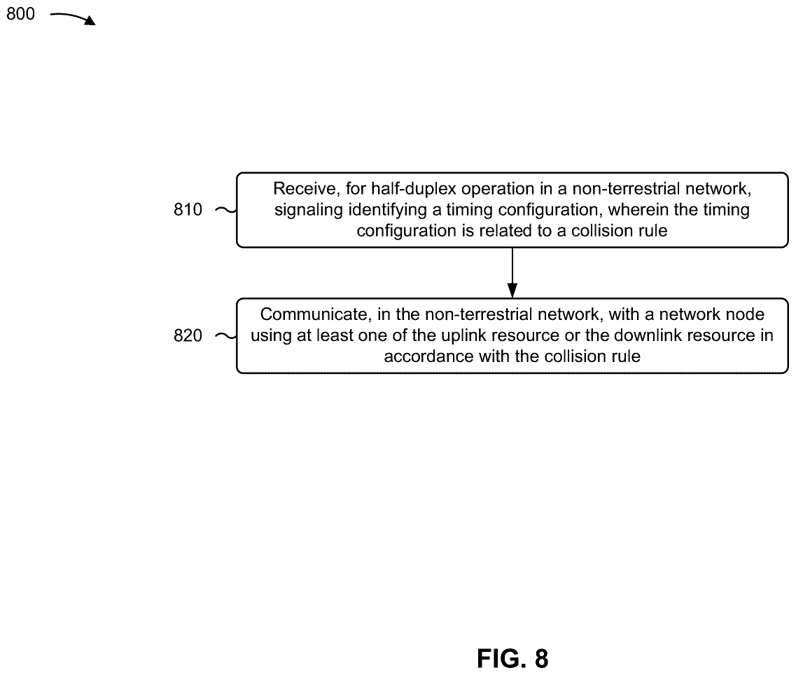

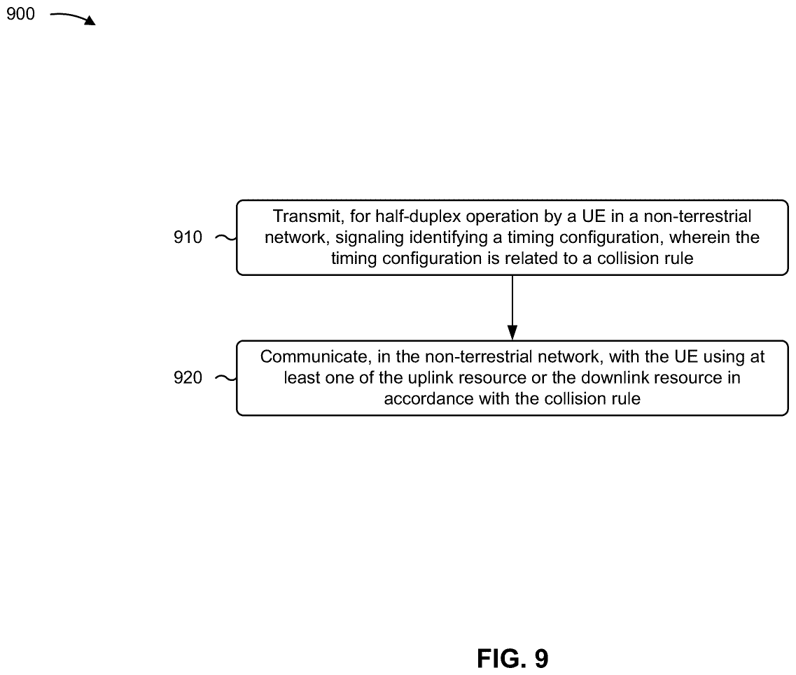

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with scheduling for NTNs, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9 or other processes as described herein. In some examples, executing instructions may include running the instructions, converting the instructions, compiling the instructions, and/or interpreting the instructions, among other examples.

As indicated above, FIG. 3 is provided as an example. Other examples may differ from what is described with regard to FIG. 3.

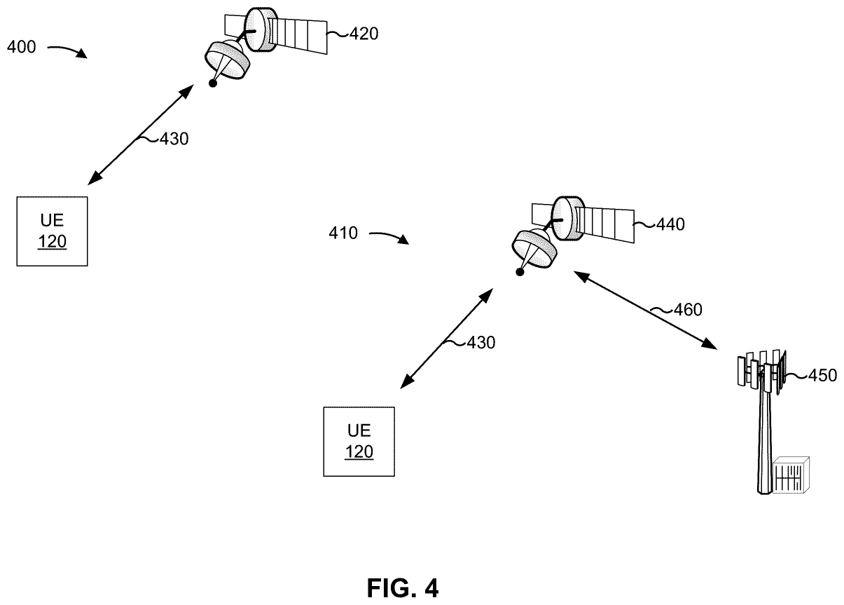

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120). An uplink of the service link 430 may be indicated by reference number 430-U (not shown in FIG. 4) and a downlink of the service link 430 may be indicated by reference number 430-D (not shown in FIG. 4). Similarly, an uplink of the feeder link 460 may be indicated by reference number 460-U (not shown in FIG. 4) and a downlink of the feeder link 460 may be indicated by reference number 460-D (not shown in FIG. 4).

As indicated above, FIG. 4 is provided as an example. Other examples may differ from what is described with regard to FIG. 4.

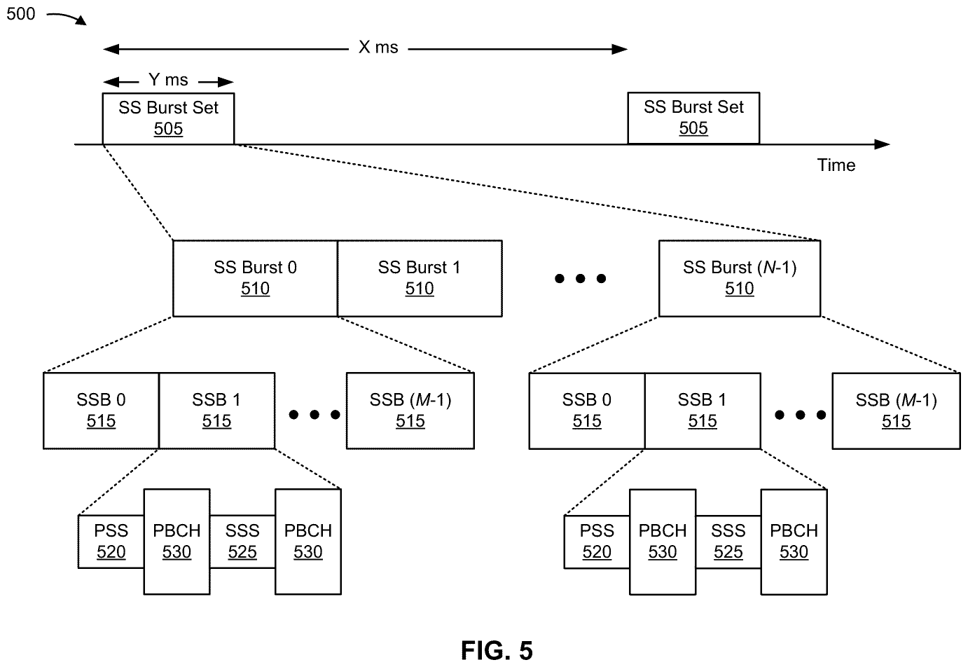

FIG. 5 is a diagram illustrating an example 500 of a synchronization signal (SS) hierarchy, in accordance with the present disclosure. As shown in FIG. 5, the SS hierarchy may include an SS burst set 505, which may include multiple SS bursts 510, shown as SS burst 0 through SS burst N−1, where N is a maximum number of repetitions of the SS burst 510 that may be transmitted by one or more network nodes. As further shown, each SS burst 510 may include one or more SS blocks (SSBs) 515, shown as SSB 0 through SSB M−1, where M is a maximum number of SSBs 515 that can be carried by an SS burst 510. In some aspects, different SSBs 515 may be beam-formed differently (e.g., transmitted using different beams), and may be used for cell search, cell acquisition, beam management, and/or beam selection (e.g., as part of an initial network access procedure). An SS burst set 505 may be periodically transmitted by a wireless node (e.g., a network node 110), such as every X milliseconds, as shown in FIG. 5. In some aspects, an SS burst set 505 may have a fixed or dynamic length, shown as Y milliseconds in FIG. 5. In some cases, an SS burst set 505 or an SS burst 510 may be referred to as a discovery reference signal (DRS) transmission window or an SSB measurement time configuration (SMTC) window.

In some aspects, an SSB 515 may include resources that carry a primary synchronization signal (PSS) 520, a secondary synchronization signal (SSS) 525, and/or a physical broadcast channel (PBCH) 530. In some aspects, multiple SSBs 515 are included in an SS burst 510 (e.g., with transmission on different beams), and the PSS 520, the SSS 525, and/or the PBCH 530 may be the same across each SSB 515 of the SS burst 510. In some aspects, a single SSB 515 may be included in an SS burst 510. In some aspects, the SSB 515 may be at least four symbols (e.g., OFDM symbols) in length, where each symbol carries one or more of the PSS 520 (e.g., occupying one symbol), the SSS 525 (e.g., occupying one symbol), and/or the PBCH 530 (e.g., occupying two symbols). In some aspects, an SSB 515 may be referred to as an SS/PBCH block.

In some aspects, the symbols of an SSB 515 are consecutive, as shown in FIG. 5. In some aspects, the symbols of an SSB 515 are non-consecutive. Similarly, in some aspects, one or more SSBs 515 of the SS burst 510 may be transmitted in consecutive radio resources (e.g., consecutive symbols) during one or more slots. Additionally, or alternatively, one or more SSBs 515 of the SS burst 510 may be transmitted in non-consecutive radio resources.

In some aspects, the SS bursts 510 may have a burst period, and the SSBs 515 of the SS burst 510 may be transmitted by a wireless node (e.g., a network node 110) according to the burst period. In this case, the SSBs 515 may be repeated during each SS burst 510. In some aspects, the SS burst set 505 may have a burst set periodicity, whereby the SS bursts 510 of the SS burst set 505 are transmitted by the wireless node according to the fixed burst set periodicity. In other words, the SS bursts 510 may be repeated during each SS burst set 505.

In some aspects, an SSB 515 may include an SSB index, which may correspond to a beam used to carry the SSB 515. A UE 120 may monitor for and/or measure SSBs 515 using different receive (Rx) beams during an initial network access procedure and/or a cell search procedure, among other examples. Based at least in part on the monitoring and/or measuring, the UE 120 may indicate one or more SSBs 515 with a best signal parameter (e.g., a reference signal received power (RSRP) parameter) to a network node 110 (e.g., directly or via one or more other network nodes). The network node 110 and the UE 120 may use the one or more indicated SSBs 515 to select one or more beams to be used for communication between the network node 110 and the UE 120 (e.g., for a random access channel (RACH) procedure). Additionally, or alternatively, the UE 120 may use the SSB 515 and/or the SSB index to determine a cell timing for a cell via which the SSB 515 is received (e.g., a serving cell).

As indicated above, FIG. 5 is provided as an example. Other examples may differ from what is described with regard to FIG. 5.

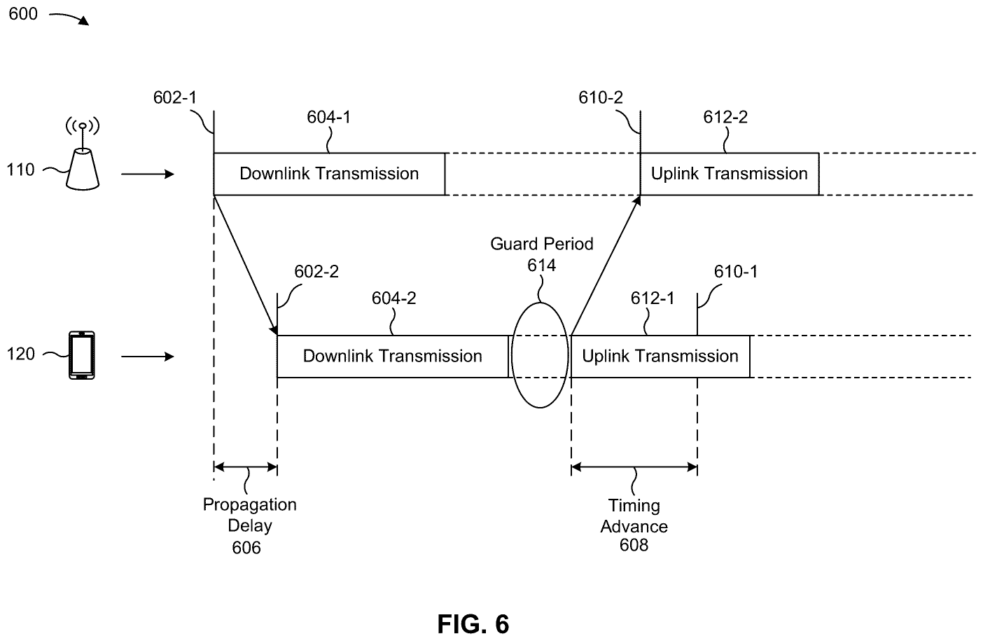

FIG. 6 is a diagram illustrating an example 600 of downlink and uplink transmissions between a network node 110 and a UE 120 in a wireless communication network 100, in accordance with the present disclosure. In some examples, the downlink and/or uplink transmissions are based at least in part on a timing advance and/or a guard period between communications. As one example, a network node 110 may configure a downlink transmission to end before the start of a guard period. As another example, the UE 120 may advance a start time for an uplink transmission based at least in part on a timing advance.

As shown by reference number 602-1, a network node 110 may begin a downlink transmission 604-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 602-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 602-1, the network node 110 may begin the downlink transmission 604-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 606 in time, such as a time delay based at least in part on the downlink transmission traveling between a network node 110 (e.g., an RU) and the UE 120. As shown by reference number 602-2, the UE 120 may receive downlink transmission 604-2 (corresponding to downlink transmission 604-1 transmitted by the network node 110) at a second point in time that is later in time relative to the first point in time. From a time perspective of the UE 120, however, the UE 120 may associate the second point in physical time shown by the reference number 602-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 600, the time perspective of the UE 120 may be delayed in time from the time perspective of the network node 110.

In wireless communication technologies like 4G/LTE and 5G/NR, a timing advance (TA) value is used to control a timing of uplink transmissions by a UE (e.g., UE 120 and/or the like) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes. However, in NTN system, relatively small propagation delays are greater than the max propagation delay that can be covered by TA field of a random access response (RAR) message (e.g., a RAR message TA field may enable indication of propagation delays of approximately 2 ms with a subcarrier spacing (SCS) of 15 kilohertz (kHz) or 1 ms with an SCS of 30 kHz).

To illustrate, without adjusting a start time of an uplink transmission, the UE 120 may be configured to begin an uplink transmission at a scheduled point in time based at least in part on the defined time partitions as described elsewhere herein. As shown by reference number 610-1, a start of the scheduled point in time may occur at a third physical point in time based at least in part on the timing perspective of the UE 120. However, and as shown by reference number 610-2, the scheduled point in time with reference to the timing perspective of the network node 110 (e.g., an RU) may occur at a fourth point in physical time that occurs before the third point in physical time as shown by the reference number 610-1. Accordingly, the network node 110 may instruct the UE 120 (e.g., directly or via one or more network nodes) to apply a timing advance 608 to an uplink transmission to better align reception of the uplink transmission with the timing perspective of the network node 110. However, in some examples, the fourth point in time shown by the reference number 610-2 may occur at or near a same physical point in time as the third point in time shown by the reference number 610-1 such that uplink transmissions from the UE 120 to the network node 110 incur the propagation delay 606. In such a scenario, the network node 110 may instruct the UE 120 to apply a timing advance with a time duration corresponding to the propagation delay 606.

As shown by the example 600, the UE 120 may adjust a start time of an uplink transmission 612-1 based at least in part on the timing advance 608 and the start of the scheduled point in time (e.g., at the third physical point in time shown by the reference number 610-1). Based at least in part on propagation delay, the network node 110 may receive an uplink transmission 612-2 (corresponding to the uplink transmission 612-1 transmitted by the UE 120) at the fourth point in physical time shown by the reference number 610-2.

In some examples, a timing advance value may be based at least in part on twice an estimated propagation delay (e.g., the propagation delay 606) and/or may be based at least in part on a round trip time (RTT). A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some examples, a telecommunication system and/or telecommunication standards may define a guard period 614 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 614 may sometimes be referred to as a gap, a switching guard period, or a guard interval.

In some examples, a network node 110 (e.g., a DU or a CU) may select a starting transmission time and/or a transmission time duration based at least in part on a receiving device and/or the guard period. For example, the network node 110 may select an amount of content (e.g., data and/or control information) to transmit in the downlink transmission 604-1 based at least in part on beginning the transmission at the first point in time shown by the reference number 602-1 and/or the UE 120 completing reception of the downlink transmission 604-2 prior to a starting point of the guard period 614. Alternatively, or additionally, the UE 120 may select an amount of content (e.g., data and/or control information) to transmit in the uplink transmission 612-1 based at least in part on the timing advance 608, the third point in time shown by the reference number 610-1, and/or refraining from beginning the uplink transmission 612-1 until the guard period 614 has ended.

As indicated above, FIG. 6 is provided as an example. Other examples may differ from what is described with regard to FIG. 6.

As described above, a network node and a UE may use one or more timing parameters to avoid interference between uplink communications and downlink communications. For example, a network node may schedule an uplink transmission for a slot n_{UL}, which may be offset from another slot n_{DL} in which a downlink transmission is scheduled. An offset parameter may be introduced to accommodate a propagation delay between transmission of a communication and reception of the communication or a tuning delay between tuning from transmission to reception, among other examples. For example, in an NTN, the network node may schedule, at a network node side, n_{UL}=n+K+K_{offset}, where n represents a slot in which a downlink transmission (e.g., a physical downlink control channel (PDCCH) occurs, K is a general offset parameter for network node and UE synchronization, and K_{offset} represents a scheduling offset for NTNs. The network node may configure a value for K_{offset} based on a cell-specific offset K_{cell,offset} and a UE-specific offset K_{UE,offset}. By including a K_{offset} value for NTNs (in addition to the general K that is used for non-NTNs as well), the network node accounts for larger RTTs associated with NTNs (relative to non-NTNs). The network node may signal a value for K_{cell,offset} in a system information block (SIB) and can configure a value for K_{UE,offset} on a per-UE basis using a medium access control (MAC) control element (CE) (MAC-CE) for connected mode UEs.

Similarly, in the NTN, the network node may schedule, at a UE side, transmission of an uplink communication at a timing n_{UL,UE}=n_{UL}−T_{TA}, where N_{UL,UE} represents a time, for the UE, at which the uplink communication is transmitted (in contrast to n_{UL}, which is the time at the network node at which the uplink communication is transmitted) and T_{TA} represents a timing advance value. The timing advance value may be based at least in part on multiple factors, such as a network controlled, cell-common timing advance value N_{TA,adj}^{common}, a UE self-estimated timing advance value N_{TA,adj}^{UE}, a timing advance offset N_{TA,offset}, or a timing advance command N_{TA}, among other examples. For example, the network node may determine T_{TA}=(N_{TA}+N_{TA,offset}+N_{TA,adj}^{common}+N_{TA,adj}^{UE})T_{c}, where T_{c} represents a timing value. Additional details of timing advance commands are described in 3GPP Technical Specification (TS) 38.211, Version 18.0.0, Release 18, Section 4.3.1 and 3GPP TS, Version 17.6.0, Release 17, 38.321 6.1.3.56, among other examples.

When a network node does not have information identifying an uplink timing advance of the UE, as may occur for a RedCap or other HD UE in an NTN, the network node may not be able to account for the guard periods when scheduling communications. Accordingly, the network node and UE may experience communication interruptions when a lack of scheduling synchronization results in transmission of a downlink communication during a period in which the UE is transmitting an uplink communication.

Various aspects relate generally to scheduling for NTNs. Some aspects more specifically relate to a set of rules, such as a collision avoidance rule or a collision resolution rule, for handling HD operation in an NTN. In some aspects, a UE, such as a RedCap UE, may receive information identifying a timing configuration relating to a collision avoidance rule, a collision resolution rule, or a timing offset value associated therewith, among other examples. In this case, the UE may communicate (e.g., on an uplink by transmitting or on a downlink by receiving) with a network node (e.g., an NTN network node) in accordance with the collision avoidance rule or the collision handling rule. The UE and the network node may use the collision avoidance rule to determine timing to attempt to avoid a collision between an uplink transmission and a downlink transmission (or a guard period). Additionally, or alternatively, the UE and the network node may use the collision resolution rule to prioritize a communication in a collision scenario where the communication collides with (e.g., is scheduled and/or occurs concurrently with) another communication.

Particular aspects of the subject matter described in this disclosure can be implemented to realize one or more of the following potential advantages. In some examples, by using a timing configuration, a collision avoidance rule, a collision resolution rule, and/or a prioritization, the described techniques can be used to maintain synchronization between a network node and a UE. Additionally, or alternatively, the described techniques can be used to avoid dropped communications between a UE and a network node. Additionally, or alternatively, the described techniques can be used to ensure that higher priority communications are not dropped (and that lower priority communications are dropped instead) in collision scenarios.

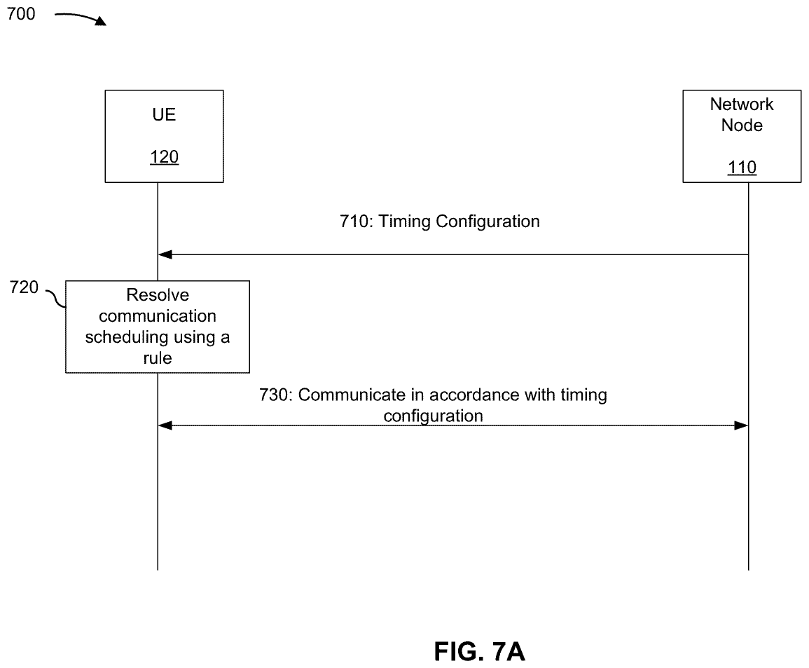

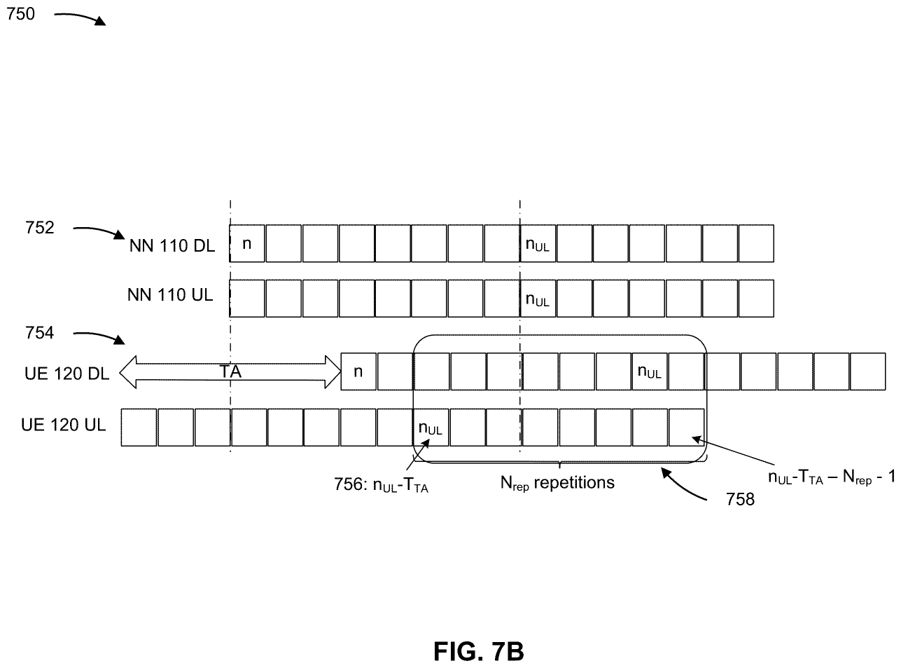

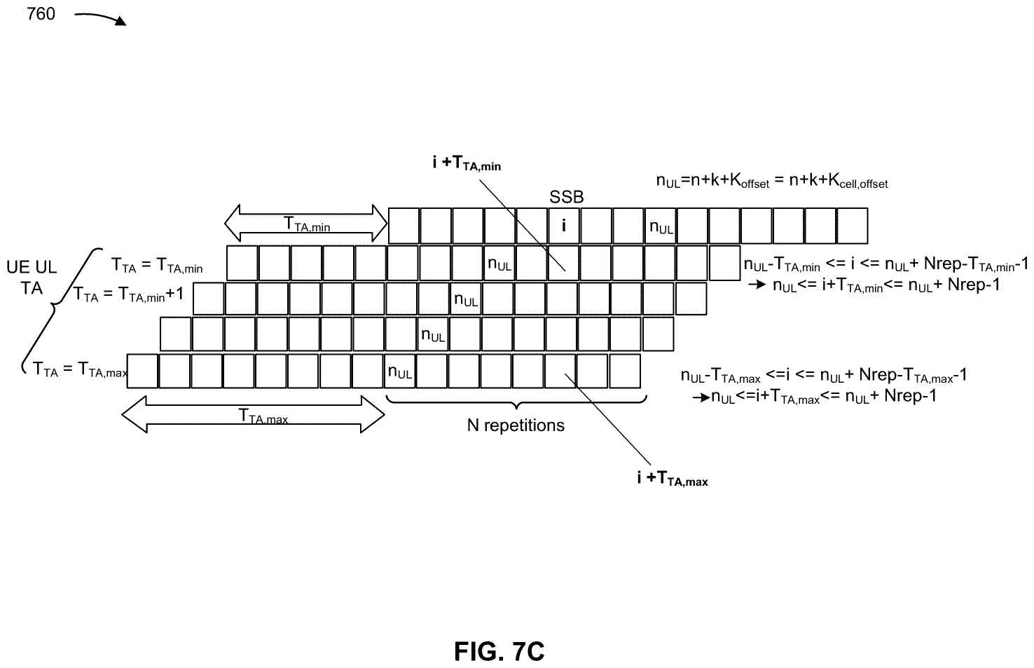

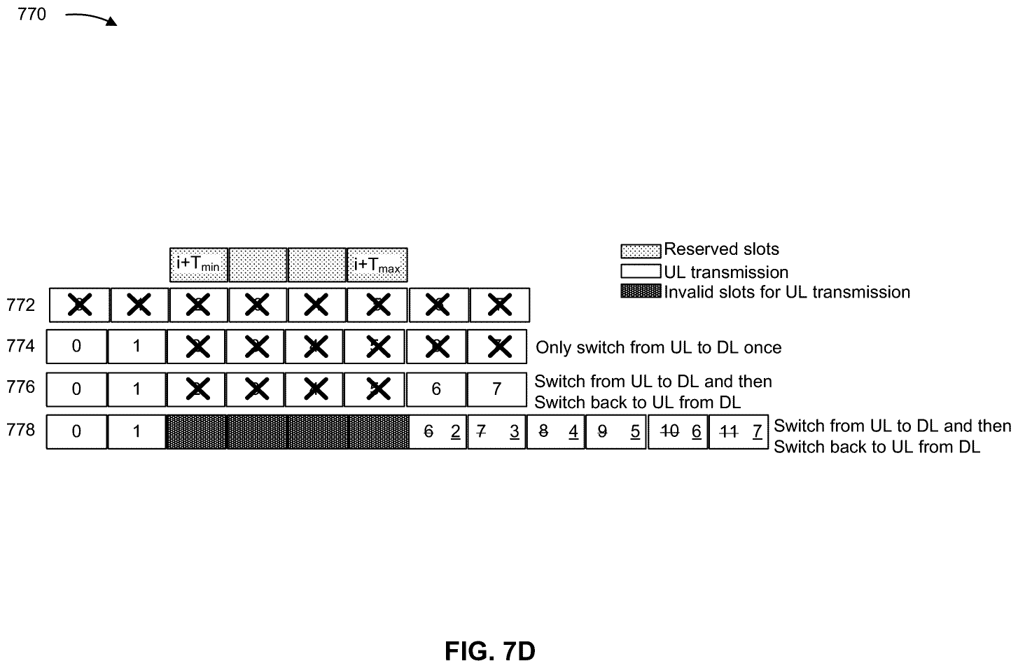

FIGS. 7A-7D are diagrams illustrating an example 700 associated with scheduling for NTNs, in accordance with the present disclosure. As shown in FIG. 7A, example 700 includes communication between a network node 110 and a UE 120.

As further shown in FIG. 7A, and by reference number 710, the UE 120 may receive signaling identifying a timing configuration. For example, the UE 120 may receive one or more communications including one or more parameters associated with scheduling of communications. In some aspects, the UE 120 may receive a system information block (SIB). For example, the network node 110 may transmit a SIB message to identify a cell-specific timing configuration to a group of UEs in a cell. Additionally, or alternatively, the UE 120 may receive UE-specific signaling. For example, the UE 120 may receive, from the network node 110, a medium access control (MAC) control element (CE) (MAC-CE) or a radio resource control (RRC) message identifying a UE-specific timing configuration. The timing configuration may include an indication of an offset value, such as K_{cell,offset} or K_{UE,offset}, as described in more detail herein, that the UE 120 may use to determine a timing of communications in a cell. For example, the UE 120 may use the timing value to determine a transmission timing of a dynamic grant PUSCH, a PUCCH feedback message, an aperiodic SRS, a CSI reference resource timing, a configured grant transmission, or an application of a timing advance command, as described in more detail herein. Additionally, or alternatively, the timing configuration may include an indication of a timing advance. Additionally, or alternatively, the timing configuration may include an indication of a reserved time. For example, the network node 110 may configure the reserved time as [i+T_{TA,min,cell}, j+T_{TA,max,cell}], as described in more detail herein. Here, the UE 120 may identify a collision or other scheduling issue when a transmission or reception is to occur at least partially at the same time as the reserved time. Accordingly, the UE 120 may apply one or more rules described herein to determine how to resolve the collision or other scheduling issue associated with the configured reserved time.

As further shown in FIG. 7A, and by reference number 720, the UE 120 may resolve communication scheduling using a rule. For example, the UE 120 may use a collision avoidance rule to determine scheduling of a set of communications and avoid a collision between an uplink communication on an uplink resource and a downlink communication on a downlink resource. Additionally, or alternatively, the UE 120 may use a collision resolution rule to resolve a collision between the uplink communication on the uplink resource and the downlink communication on the downlink resource. In this case, the UE 120 may use a prioritization associated with the timing configuration to resolve the collision, as described in more detail herein.

In some aspects, the UE 120 may identify a possible collision. As shown in FIG. 7B, and by diagram 750, a result of an RTT gap between the network node 110 and the UE 120 is that the network node 110 and the UE 120 have different timings for uplink slots and downlink slots. For example, the network node 110 is associated with a first timing 752 and the UE 120 is associated with a second timing 754. As shown, the UE 120 downlink timing is offset from the UE 120 uplink timing by a timing advance value TA. The network node 110 may schedule a slot n_{UL} as a ninth slot in a set of slots in the first timing 752, which may correspond to a different slot location in the second timing 754. For example, the ninth slot in the UE 120's uplink occurs at a time 756 that is n_{UL}−T_{TA,min}. When a quantity Nᵣₑₚ of repetitions are configured for the uplink transmission, a collision may occur in a group of slots 758 from n_{UL}−T_{TA} through n_{UL}−T_{TA}−Nᵣₑₚ−1. Because T_{TA} is related to a value of N_{TA,adj}^{UE}, which is determined by the UE 120, the network node 110 may not know which slots, in the second timing 754, are subject to a potential collision, and may not be able to schedule to avoid a collision, as described above.

In some aspects, the UE 120 may use a collision avoidance rule to avoid a collision between an uplink communication on an uplink resource and a downlink communication on a downlink resource. For example, when the UE 120 is an HD-FDD UE in an RRC idle or RRC inactive state, and when a potential collision is between an SSB transmission and a non-UE-specific dynamic grant (DG) uplink (UL) transmission, the UE 120 may use a cell-specific offset as a timing offset. For example, a non-UE-specific dynamically scheduled UL may be scheduled with K_{offset}=K_{cell,offset} (e.g., rather than K_{offset}=K_{cell,offset}+K_{UE,offset}). In this case, by avoiding using the K_{UE,offset} that is UE-estimated, the network node 110 can avoid a collision between the SSB and the non-UE-specific DG UL transmission, such as a physical uplink control channel (PUCCH), a random access channel (RACH) message B (msgB) radio network temporary identifier (RNTI) (msgB-RNTI), a temporary cell-specific RNTI (TC-RNTI), a random access response (RAR) or fallback RAR grant scheduled physical uplink shared channel (PUSCH), or a RACH message 3 (msg3) PUSCH with a TC-RNTI, among other examples.

In some aspects, the network node 110 may configure a reserved time to avoid a collision between the SSB transmission and the non-UE-specific DG UL transmission. For example, the UE 120 may receive a SIB including information identifying a reserved time [i+T_{TA,min,cell}, j+T_{TA,max,cell}], where i and j represents a starting and end slot for SSB transmission. In this case, the network node 110 may estimate a value for T_{TA,min}, cell and T_{TA,max,cell} based at least in part on a UE 120 location within a cell (e.g., a minimum and maximum distance between a satellite of the network node 110 and the UE 120 within the cell), where the reserve time may also take into account the switching time. As shown in FIG. 7C, and by diagram 760, the UE 120 is associated with a set of possible timing advance values T_{TA,min} and T_{TA,max}. Accordingly, the UE 120 may determine to receive an SSB during the downlink slot i to j that is within a reserved time reserved to avoid collision with an uplink transmission n_{UL}.

In some aspects, the network node 110 and the UE 120 may have a prioritization relating to a collision avoidance rule or a collision resolution rule. For example, when a downlink is an SSB and an uplink is a non-UE-specific DG UL with K_{offset}=K_{cell,offset}, the UE 120 may be configured to cancel an uplink transmission if at least one uplink slot (or at least one symbol, resource element, resource block, or other communication resource) is overlapped with a reserved time signaled by the network node 110. As shown in FIG. 7D, and by diagram 770, a reserved time may be configured for slots 2 through 5 of a set of 8 slots that are scheduled with a non-UE-specific DG UL communication. In this case, as shown by reference number 772, the UE 120 may cancel the non-UE-specific DG UL communication in slots 0 through 7 based on a collision in slots 2 through 5. In another example, the UE 120 may be configured to cancel the uplink transmission from a first slot that overlaps with the reserved time. In other words, an overlap may be configured to occur when a first transmission is scheduled for the same time resources and/or frequency resources as a second transmission or when a transmission is scheduled for the same time resources and/or frequency resources that are allocated for a guard period, reserved time, switching time, or another type of configured period. In this case, as shown by reference number 774, the UE 120 may switch from uplink to downlink a single time and may cancel the uplink transmission in slots 2 through 7 (but may perform uplink transmission in slots 0 and 1). In another example, the UE 120 may be configured to drop one or more slots of an uplink transmission that actually overlap with the reserved time (but may allow non-overlapping slots). In this case, as shown by reference number 776, the UE 120 may transmit on an uplink in slots 0 and 1, switch from uplink to downlink to receive an SSB in slots 2 through 5 (dropping uplink transmission), and may switch from downlink to uplink to transmit in slots 6 and 7.

In another example, the UE 120 may be configured to not count the reserved time for the uplink transmission. In other words, when the UE 120 receives a DG scheduling uplink transmission for 8 slots starting from slot 0 and when slots 2 through 5 are reserved, the UE 120 interprets the DG scheduling as indicating that the uplink transmission is to occur in slots 0 and 1, have a gap for 4 slots of downlink, and then continue with slots 2 through 7 after the reserved time is elapsed (e.g., slots 2 through 7 may shift from an original position to slots 6 through 11), as shown by reference number 778. In another example, when the UE 120 has not received an indication of a reserved time, the UE 120 may drop uplink transmission in a slot that overlaps with a downlink slot for the SSB and the network node 110 may attempt to blind detect whether there is an uplink transmission (or not), e.g., by detecting an uplink demodulation reference signal (DMRS) in the uplink transmission.

In some aspects, the UE 120 and the network node 110 may apply a collision avoidance rule or a collision resolution rule for a scenario when the UE 120 is an HD-FDD UE in an RRC connected state and when a potential collision is between an SSB and a UE-specific DG or configured grant (CG) (DG/CG) UL transmission. Examples of DG UL transmissions may include a PUCCH (e.g., for hybrid automatic repeat request (HARQ) acknowledgment (ACK) feedback)), a PUSCH (e.g., a DG PUSCH), or a sounding reference signal (SRS) (e.g., an aperiodic SRS) transmission, among other examples. Examples of CG (e.g., RRC-configured) UL transmissions include a PUSCH (e.g., a CG-PUSCH), a PUCCH (e.g., a physical RACH (PRACH) message A (msgA) for contention-free random access (CFRA) or a periodic PUCCH), or an SRS (e.g., a periodic or semi-persistent SRS), among other examples. In these cases, the UE 120 may be configured with the UE-specific DG/CG UL transmission at a timing associated with K_{offset}=K_{cell,offset}+K_{UE,offset}, with K_{UE,offset} being configured and updated via a MAC-CE transmission or being associated with a default value (e.g., 0). In some aspects, the network node 110 may configure the reserved time for the UE 120 using unicast RRC signaling (e.g., to avoid a collision between the SSB, in a slot i, and the DG/CG UL transmission). For example, as described above, the network node 110 may estimate timing advance values for the reserved time based on a UE-reported timing advance (TA) or a UE location. In this case, a size of the reserved time may correspond to an accuracy or granularity of the UE-reported TA or location. In other words, when the network node 110 receives a more accurate reporting of the UE TA or the UE location, the network node 110 may configure a shorter reserved time. Coarse granularity location information reported by the UE 120 (e.g., with the accuracy level that corresponds to a granularity of approximately a few kilometers (km)) may not be sufficient for some use cases. Accordingly, finer granularity location information may be requested by the network node 110 to reduce the reserved time. Similarly, a timing advance report MAC-CE may be triggered to report a quantity of slots greater than or equal to the timing advance value, where a field size of the MAC-CE command may be increased or an additional delta value provided to report the value in terms of symbols, which may improve granularity.

In some aspects, the UE 120 may apply a prioritization in connection with a potential collision between an SSB and a UE-specific DG/CG UL transmission or between an SSB and a UE-specific RRC configured UL. For example, when the UE 120 is configured with an SSB that potentially collides with a UE-specific DG/CG UL, and when K_{offset}=K_{cell,offset}+K_{UE,offset}, the UE 120 may cancel all of an uplink transmission if at least one slot overlaps with the reserved time (as shown by 772). Additionally, or alternatively, the UE 120 may cancel the uplink transmission from a first slot that overlaps with the reserved time (as shown by 774). Additionally, or alternatively, the UE 120 may drop a slot of an uplink transmission that actually overlaps with the reserved time (as shown by 776). Additionally, or alternatively, the UE 120 may not count the reserved time toward a set of slots for which the uplink transmission is scheduled (as shown by 778). Additionally, or alternatively, when the network node 110 does not provide an indication of the reserved time, the UE 120 may drop uplink transmission in a slot that overlaps with the downlink slot with an SSB and the network node 110 may blind detect whether there is uplink transmission or not (e.g., based on the UL DMRS detection (or other reference signal)).

In some aspects, the UE 120 and the network node 110 may apply a collision avoidance rule or a collision resolution rule for a scenario when the UE 120 is an HD-FDD UE in an RRC connected state and when a potential collision is between a UE-specific DG/CG downlink (DL) transmission and a non-UE-specific DG UL transmission. In this case, the non-UE-specific DG UL may be shared by a plurality of RRC connected state UEs and RRC idle or inactive state UEs with relatively large TA values that are unknown to the network node 110 (in an NTN), which may result in the network node 110 not being able to apply a collision avoidance rule or technique. In this case, the UE 120 and the network node 110 may apply a collision resolution rule by prioritizing the DL transmission or the UL transmission, as described below. In some aspects, the network node 110 may configure a reserved time [i+T_{TA,min,cell}, j+T_{TA,max,cell}] via a SIB, where i represents a starting DL slot and j represents an ending DL slot of the DL resources.

In some aspects, the UE 120 may apply a prioritization to resolve a collision between a DG DL transmission (e.g., an aperiodic (AP) channel state information (CSI) reference signal (RS) (CSI-RS) (AP-CSI-RS) or physical downlink shared channel (PDSCH)) and a non-UE-specific DG UL transmission with K_{offset}=K_{cell,offset}. Similarly, the UE 120 may apply the prioritization to resolve a collision with an RRC (e.g., CG) configured DL transmission (e.g., a PDCCH, a PDSCH, a periodic (P) or semi-persistent (SP) (P/SP) CSI-RS, or a paging reference signal (PRS)). For example, the UE 120 may drop all of the DL transmission if at least one UL slot is overlapped with the reserved time. Additionally, or alternatively, the UE 120 may drop the DL slot in the reserved time that overlaps with the UL slots. Additionally, or alternatively, when the network node 110 does not provide an indication of the reserved time, the UE 120 may prioritize the DL or the UL transmission (e.g., based at least in part on a UE implementation, a specification, or another priority value, among other examples), and the network node 110 may use blind detection on a UL DMRS to determine whether the UE 120 has prioritized the DL or the UL transmission.

In some aspects, the UE 120 and the network node 110 may apply a collision avoidance rule or a collision resolution rule for a scenario when the UE 120 is an HD-FDD UE in an RRC connected state and when a potential collision is between a DG/CG DL transmission and a UE-specific DG UL transmission. In some aspects, the network node 110 may configure a reserved time [i+T_{TA,min,cell}, j+T_{TA,max,cell}] via RRC signaling, where i represents a starting DL slot and j represents an ending DL slot. In some aspects, the UE 120 may apply a prioritization to resolve a collision between a DG DL transmission (e.g., an AP-CSI-RS or a PDSCH) and a UE-specific DG UL transmission (e.g., a PUCCH, a PUSCH, or an SRS) with K_{offset}=K_{cell,offset}+K_{UE,offset}. For example, the UE 120 may cancel all of the UL transmission if at least one UL slot is overlapped with the reserved time. Additionally, or alternatively, the UE 120 may cancel the UL transmission from the first slot that overlaps with the reserved time. Additionally, or alternatively, the UE 120 may drop slots of the UL transmission that overlap with the reserved time. Additionally, or alternatively, the UE 120 may not count the reserved time toward scheduling slots of the UL transmission. Additionally, or alternatively, the UE 120 may drop the UL transmission in slots that overlap with the DL transmission and the network node 110 may perform blind detection on, for example, a UL DMRS (or another signal). Similarly, the UE 120 may apply a prioritization to resolve a collision between an RRC configured DL transmission (e.g., a PDCCH, a PDSCH, a P/SP CSI-RS, or a PRS) and a UE-specific DG UL transmission. For example, the UE 120 may not count the reserved time toward scheduling slots of the UL transmission. Additionally, or alternatively, the UE 120 may drop all of the DL transmission if at least one UL slot is overlapped with the reserved time. Additionally, or alternatively, the UE 120 may drop the DL transmission in a slot of the reserved time overlapping with the UL transmission. Additionally, or alternatively, if the network node 110 does not indicate the reserved time, the UE 120 may drop the DL transmission or the UL transmission and the network node 110 may perform blind detection on, for example, an UL DMRS (or another signal).

In some aspects, the UE 120 and the network node 110 may apply a collision avoidance rule or a collision resolution rule for a scenario when the UE 120 is an HD-FDD UE in an RRC connected state and when a potential collision is between a UE-specific DG/CG DL transmission and a UE-specific CG UL transmission. In some aspects, the network node 110 may configure a reserved time [i+T_{TA,min,cell}, j+T_{TA,max,cell}] via RRC signaling. In some aspects, the UE 120 may apply a prioritization to resolve a collision. For example, the UE 120 may prioritize DG DL transmission over CG UL transmission or may prioritize CG DL transmission over CG UL transmission. Additionally, or alternatively, the UE 120 may resolve a collision between a DG DL transmission (e.g., an AP-CSI-RS or a PDSCH) and a UE-specific CG UL transmission (e.g., a CG-PUSCH, a PRACH and msgA for CFRA, an SRS, or a PUCCH) with K_{offset}=K_{cell,offset}+K_{UE,offset}. Similarly, the UE 120 may apply the prioritization to resolve a collision between an RRC configured DL transmission (e.g., a PDCCH, a PDSCH, a P/SP CSI-RS, or a PRS) and the UE-specific RRC configured UL transmission. For example, the UE 120 may treat such a scenario as an error case and may perform an error recovery action (e.g., transmit a message, drop a communication, etc.). For example, the UE 120 may cancel all of the UL transmission if at least one UL slot is overlapped with the reserved time. Additionally, or alternatively, the UE 120 may cancel the UL transmission from the first slot that overlaps with the reserved time. Additionally, or alternatively, the UE 120 may drop slots of the UL transmission that overlap with the reserved time. Additionally, or alternatively, the UE 120 may not count the reserved time toward scheduling slots of the UL transmission. Additionally, or alternatively, the UE 120 may drop the UL transmission in slots that overlap with the DL transmission and the network node 110 may perform blind detection on, for example, a UL DMRS (or another signal).

In some aspects, the UE 120 and the network node 110 may apply a collision avoidance rule or a collision resolution rule for a scenario when the UE 120 is an HD-FDD UE in an RRC connected state and when a potential collision is between a cell-specific PDCCH and a UE-specific CG UL transmission (e.g., a CG-PUSCH, a PRACH and msgA for CFRA, an SRS, or a PUCCH) with K_{offset}=K_{cell,offset}+K_{UE,offset}. In this case, the cell-specific PDCCH monitoring (e.g., broadcasted by a SIB) may be associated with a type-0, type-0A, type-OB, type-1, type-1A, type-2, or type 2A PDCCH common search space (CSS) set. In some aspects, the network node 110 may configure a reserved time [i+T_{TA,min,cell}, j+T_{TA,max,cell}] via RRC signaling, where i and j are the index of a logical DL starting slot and ending slot of the PDCCH monitoring duration of the CSS. In some aspects, the UE 120 may apply a prioritization to resolve the collision. For example, the UE 120 may prioritize DL cell-specific PDCCH monitoring over CG UL transmission. In this case, the UE 120 may cancel all of the UL transmission if at least one UL slot is overlapped with the reserved time. Additionally, or alternatively, the UE 120 may cancel the UL transmission from the first slot that overlaps with the reserved time. Additionally, or alternatively, the UE 120 may drop slots of the UL transmission that overlap with the reserved time. Additionally, or alternatively, the UE 120 may not count the reserved time toward scheduling slots of the UL transmission. Additionally, or alternatively, the UE 120 may drop the UL transmission in slots that overlap with the DL transmission and the network node 110 may perform blind detection on, for example, a UL DMRS (or another signal).

In some aspects, the UE 120 may apply a collision avoidance rule or a collision resolution rule based at least in part on a UE capability or a UE state. For example, the UE 120 may apply a first collision avoidance or collision resolution rule when the UE is capable of reporting a TA value, reporting a UE location, or is operating in an RRC connected state. Additionally, or alternatively, when the UE 120 is not capable of reporting a TA value or a UE location or is not operating in the RRC connected state (e.g., is operating in an RRC inactive or idle state), the UE 120 may apply a second collision avoidance or collision resolution rule. Based on applying a collision avoidance or collision resolution rule, the UE 120 and/or the network node 110 may tune to a particular mode, such as the UE 120 tuning to an uplink transmission mode or tuning to a downlink reception mode (e.g., for receiving a downlink transmission from the network node 110).

Returning to FIG. 7A, and as shown by reference number 730, the UE 120 may communicate in accordance with the collision avoidance rule or the collision handling rule. For example, based on having received a timing configuration identifying a reserved time, the UE 120 may use a rule, as described above, to resolve a conflict, collision, or other scheduling issue with the reserved time, thereby enabling the UE 120 to communicate in accordance with the collision avoidance rule or the collision handling rule. The UE 120 may communicate in accordance with the collision avoidance rule or the collision handling rule by applying the rule deterministically, such that the network node 110 remains synchronized with regard to a behavior of the UE 120 with respect to the reserved time. In other words, the UE 120 communicates in accordance with the collision avoidance rule or the collision handling rule by applying a rule that the network node 110 expects the UE 120 to apply and by transmitting or receiving, among other examples as is expected by the network node 110. Based at least in part on resolving communication scheduling to ensure that a collision does not occur and a communication is not inadvertently dropped (but may be selected for dropping, as described above), the UE 120 may communicate with the network node 110. For example, the UE 120 may transmit an uplink communication on an uplink resource or receive a downlink communication on a downlink resource, among other examples.

As indicated above, FIGS. 7A-7D is provided as an example. Other examples may differ from what is described with respect to FIGS. 7A-7D.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with scheduling for NTNs.

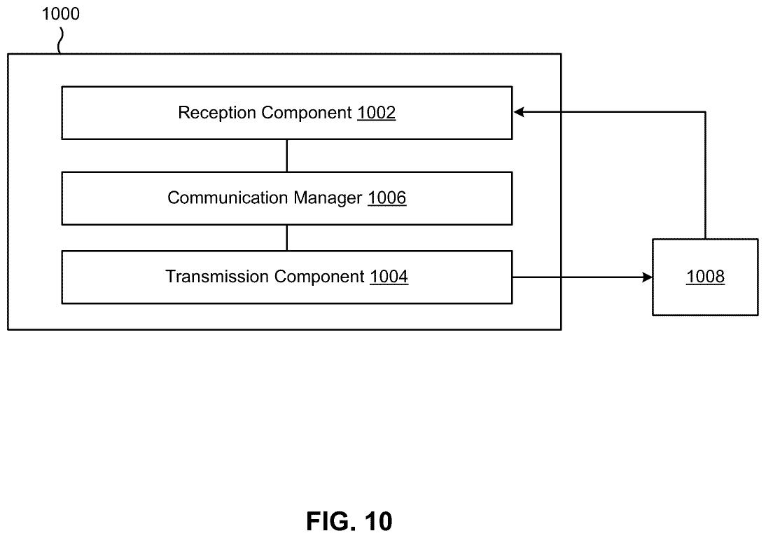

As shown in FIG. 8, in some aspects, process 800 may include receiving, for half-duplex operation in a non-terrestrial network, signaling identifying a timing configuration, wherein the timing configuration is related to a collision rule (block 810). For example, the UE (e.g., using reception component 1002 and/or communication manager 1006, depicted in FIG. 10) may receive, for half-duplex operation in a non-terrestrial network, signaling identifying a timing configuration, wherein the timing configuration is related to a collision avoidance rule or a collision handling rule, as described above. In some aspects, the collision avoidance rule or the collision handling rule is related to an overlapping between a downlink resource and an uplink resource associated with an offset parameter.

As further shown in FIG. 8, in some aspects, process 800 may include communicating, in the non-terrestrial network, with a network node using at least one of the uplink resource or the downlink resource in accordance with the collision rule (block 820). For example, the UE (e.g., using reception component 1002, transmission component 1004, and/or communication manager 1006, depicted in FIG. 10) may communicate, in the non-terrestrial network, with a network node using at least one of the uplink resource or the downlink resource in accordance with the collision avoidance rule or the collision handling rule, as described above.

Process 800 may include additional aspects, such as any single aspect or any combination of aspects described below and/or in connection with one or more other processes described elsewhere herein.

In a first aspect, the uplink resource is a non-UE-specific, dynamically-scheduled uplink resource associated with the offset parameter, wherein the offset parameter is a cell-specific offset parameter.

In a second aspect, alone or in combination with the first aspect, the uplink resource is a dynamically-scheduled uplink resource or a UE-specific statically-scheduled uplink resource associated with the offset parameter, wherein the offset parameter is at least one of a cell-specific offset parameter, a UE-specific offset parameter, or any combination thereof.

In a third aspect, alone or in combination with one or more of the first and second aspects, the signaling includes an indication of a reserved time associated with at least one of a coverage area of a cell, a location of the UE within a cell, a timing advance parameter of the UE, or any combination thereof.

In a fourth aspect, alone or in combination with one or more of the first through third aspects, the timing configuration is conveyed via at least one of a system information block, a MAC-CE, an RRC message, or any combination thereof.

In a fifth aspect, alone or in combination with one or more of the first through fourth aspects, communicating with the network node comprises receiving a synchronization signal block transmission in the downlink resource, or transmitting an uplink communication in the uplink resource.

In a sixth aspect, alone or in combination with one or more of the first through fifth aspects, the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.

In a seventh aspect, alone or in combination with one or more of the first through sixth aspects, the collision avoidance rule or the collision handling rule is associated with a reserved time for a downlink resource of a synchronization signal block, the reserved time not being counted for the uplink resource.

In an eighth aspect, alone or in combination with one or more of the first through seventh aspects, the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.

In a ninth aspect, alone or in combination with one or more of the first through eighth aspects, the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.

In a tenth aspect, alone or in combination with one or more of the first through ninth aspects, the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.

In an eleventh aspect, alone or in combination with one or more of the first through tenth aspects, the collision avoidance rule or the collision handling rule is associated with a reserved time corresponding to a downlink resource with a configured grant or a dynamic grant, the reserved time not being counted for the uplink resource with the configured grant or the dynamic grant.

In a twelfth aspect, alone or in combination with one or more of the first through eleventh aspects, the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.

In a thirteenth aspect, alone or in combination with one or more of the first through twelfth aspects, the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.

In a fourteenth aspect, alone or in combination with one or more of the first through thirteenth aspects, the collision handling rule is associated with a prioritization of downlink control channel monitoring of the downlink resource relative to an uplink resource with a configured grant if overlapping at least one symbol during a reserved time associated with downlink control channel monitoring of the downlink resource.

In a fifteenth aspect, alone or in combination with one or more of the first through fourteenth aspects, the collision avoidance rule or the collision handling rule is associated with a reserved time corresponding to downlink control channel monitoring of the downlink resource, and the reserved time is not counted for the uplink resource with a configured grant.

In a sixteenth aspect, alone or in combination with one or more of the first through fifteenth aspects, the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.

In a seventeenth aspect, alone or in combination with one or more of the first through sixteenth aspects, the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.

In an eighteenth aspect, alone or in combination with one or more of the first through seventeenth aspects, the collision avoidance rule or the collision handling rule is based at least in part on whether a timing advance is estimated in connection with a UE reported timing advance or location.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with scheduling for NTNs.

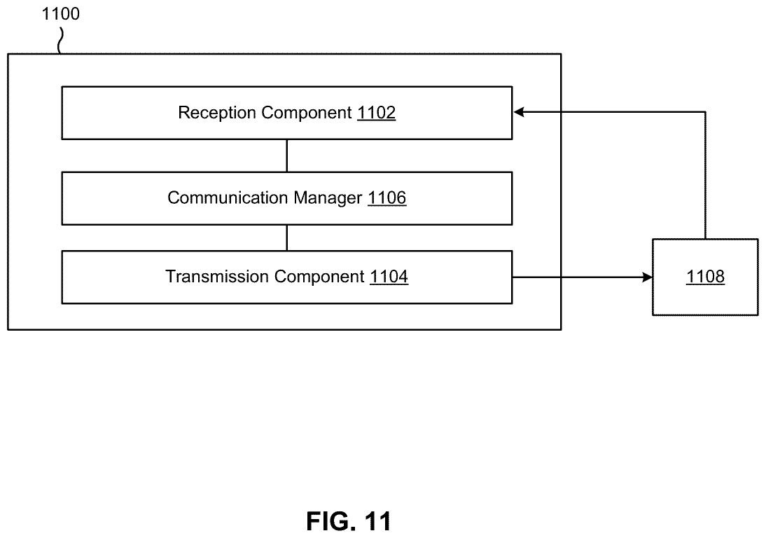

As shown in FIG. 9, in some aspects, process 900 may include transmitting, for half-duplex operation by a UE in a non-terrestrial network, signaling identifying a timing configuration, wherein the timing configuration is related to a collision rule (block 910). For example, the network node (e.g., using transmission component 1104 and/or communication manager 1106, depicted in FIG. 11) may transmit, for half-duplex operation by a UE in a non-terrestrial network, signaling identifying a timing configuration, wherein the timing configuration is related to a collision avoidance rule or a collision handling rule, as described above. In some aspects, the collision avoidance rule or the collision handling rule is related to an overlapping between a downlink resource and an uplink resource associated with an offset parameter.

As further shown in FIG. 9, in some aspects, process 900 may include communicating, in the non-terrestrial network, with the UE using at least one of the uplink resource or the downlink resource in accordance with the collision rule (block 920). For example, the network node (e.g., using reception component 1102, transmission component 1104, and/or communication manager 1106, depicted in FIG. 11) may communicate, in the non-terrestrial network, with the UE using at least one of the uplink resource or the downlink resource in accordance with the collision avoidance rule or the collision handling rule, as described above.

Process 900 may include additional aspects, such as any single aspect or any combination of aspects described below and/or in connection with one or more other processes described elsewhere herein.

In a first aspect, the uplink resource is a non-UE-specific, dynamically-scheduled uplink resource associated with the offset parameter, wherein the offset parameter is a cell-specific offset parameter.

In a second aspect, alone or in combination with the first aspect, the uplink resource is a dynamically-scheduled uplink resource or a UE-specific statically-scheduled uplink resource associated with the offset parameter, wherein the offset parameter is at least one of a cell-specific offset parameter, a UE-specific offset parameter, or any combination thereof.

In a third aspect, alone or in combination with one or more of the first and second aspects, the signaling includes an indication of a reserved time associated with at least one of a coverage area of a cell, a location of the UE within a cell, a timing advance parameter of the UE, or any combination thereof.

In a fourth aspect, alone or in combination with one or more of the first through third aspects, the timing configuration is conveyed via at least one of a system information block, a MAC-CE, an RRC message, or any combination thereof.

In a fifth aspect, alone or in combination with one or more of the first through fourth aspects, communicating with the UE comprises transmitting a synchronization signal block transmission in the downlink resource, or receiving an uplink communication in the uplink resource.

In a sixth aspect, alone or in combination with one or more of the first through fifth aspects, the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.

In a seventh aspect, alone or in combination with one or more of the first through sixth aspects, the collision avoidance rule or the collision handling rule is associated with a reserved time for a downlink resource of a synchronization signal block, the reserved time not being counted for the uplink resource.

In an eighth aspect, alone or in combination with one or more of the first through seventh aspects, the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.

In a ninth aspect, alone or in combination with one or more of the first through eighth aspects, the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.

In a tenth aspect, alone or in combination with one or more of the first through ninth aspects, the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.

In an eleventh aspect, alone or in combination with one or more of the first through tenth aspects, the collision avoidance rule or the collision handling rule is associated with a reserved time corresponding to a downlink resource with a configured grant or a dynamic grant, the reserved time not being counted for the uplink resource with the configured grant or the dynamic grant.

In a twelfth aspect, alone or in combination with one or more of the first through eleventh aspects, the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.

In a thirteenth aspect, alone or in combination with one or more of the first through twelfth aspects, the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.

In a fourteenth aspect, alone or in combination with one or more of the first through thirteenth aspects, the collision handling rule is associated with a prioritization of downlink control channel monitoring of the downlink resource relative to an uplink resource with a configured grant if overlapping at least one symbol during a reserved time associated with downlink control channel monitoring of the downlink resource.

In a fifteenth aspect, alone or in combination with one or more of the first through fourteenth aspects, the collision avoidance rule or the collision handling rule is associated with a reserved time corresponding to downlink control channel monitoring of the downlink resource, and the reserved time is not counted for the uplink resource with a configured grant.

In a sixteenth aspect, alone or in combination with one or more of the first through fifteenth aspects, the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.

In a seventeenth aspect, alone or in combination with one or more of the first through sixteenth aspects, the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.

In an eighteenth aspect, alone or in combination with one or more of the first through seventeenth aspects, the collision avoidance rule or the collision handling rule is based at least in part on whether a timing advance is estimated in connection with a UE reported timing advance or location.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7A-7D. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The reception component 1002 and/or the transmission component 1004 may communicate, in the non-terrestrial network, with a network node using at least one of the uplink resource or the downlink resource in accordance with the collision avoidance rule or the collision handling rule.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7D. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, for half-duplex operation by a UE in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter. The reception component 1102 and/or the transmission component 1104 may communicate, in the non-terrestrial network, with the UE using at least one of the uplink resource or the downlink resource in accordance with the collision avoidance rule or the collision handling rule.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving, for half-duplex operation in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter; and communicating, in the non-terrestrial network, with a network node using at least one of the uplink resource or the downlink resource in accordance with the collision avoidance rule or the collision handling rule.
Aspect 2: The method of Aspect 1, wherein the uplink resource is a non-UE-specific, dynamically-scheduled uplink resource associated with the offset parameter, wherein the offset parameter is a cell-specific offset parameter.
Aspect 3: The method of any of Aspects 1-2, wherein the uplink resource is a dynamically-scheduled uplink resource or a UE-specific statically-scheduled uplink resource associated with the offset parameter, wherein the offset parameter is at least one of: a cell-specific offset parameter, a UE-specific offset parameter, or any combination thereof.
Aspect 4: The method of any of Aspects 1-3, wherein the signaling includes an indication of a reserved time associated with at least one of a coverage area of a cell, a location of the UE within the cell, a timing advance parameter of the UE, or any combination thereof.
Aspect 5: The method of any of Aspects 1-4, wherein the timing configuration is conveyed via at least one of: a system information block, a medium access control (MAC) control element (CE), a radio resource control (RRC) message, or any combination thereof.
Aspect 6: The method of any of Aspects 1-5, wherein communicating with the network node comprises: receiving a synchronization signal block transmission in the downlink resource, or transmitting an uplink communication in the uplink resource.
Aspect 7: The method of any of Aspects 1-6, wherein the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.
Aspect 8: The method of any of Aspects 1-7, wherein the collision avoidance rule or the collision handling rule is associated with a reserved time for a downlink resource of a synchronization signal block, the reserved time not being counted for the uplink resource.
Aspect 9: The method of any of Aspects 1-8, wherein the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.
Aspect 10: The method of any of Aspects 1-9, wherein the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.
Aspect 11: The method of any of Aspects 1-10, wherein the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.
Aspect 12: The method of any of Aspects 1-11, wherein the collision avoidance rule or the collision handling rule is associated with a reserved time corresponding to a downlink resource with a configured grant or a dynamic grant, the reserved time not being counted for the uplink resource with the configured grant or the dynamic grant.
Aspect 13: The method of any of Aspects 1-12, wherein the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.
Aspect 14: The method of any of Aspects 1-13, wherein the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.
Aspect 15: The method of any of Aspects 1-14, wherein the collision handling rule is associated with a prioritization of downlink control channel monitoring of the downlink resource relative to an uplink resource with a configured grant if overlapping at least one symbol during a reserved time associated with downlink control channel monitoring of the downlink resource.
Aspect 16: The method of any of Aspects 1-15, wherein the collision avoidance rule or the collision handling rule is associated with a reserved time corresponding to downlink control channel monitoring of the downlink resource, and wherein the reserved time is not counted for the uplink resource with a configured grant.
Aspect 17: The method of any of Aspects 1-16, wherein the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.
Aspect 18: The method of any of Aspects 1-17, wherein the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.
Aspect 19: The method of any of Aspects 1-18, wherein the collision avoidance rule or the collision handling rule is based at least in part on whether a timing advance is estimated in connection with a UE reported timing advance or location.
Aspect 20: A method of wireless communication performed by a network node, comprising: transmitting, for half-duplex operation by a user equipment (UE) in a non-terrestrial network, signaling identifying a timing configuration, wherein the timing configuration is related to a collision avoidance rule or a collision handling rule, wherein the collision avoidance rule or the collision handling rule is related to an overlapping between a downlink resource and an uplink resource associated with an offset parameter; and communicating, in the non-terrestrial network, with the UE using at least one of the uplink resource or the downlink resource in accordance with the collision avoidance rule or the collision handling rule.
Aspect 21: The method of Aspect 20, wherein the uplink resource is a non-UE-specific, dynamically-scheduled uplink resource associated with a cell-specific offset parameter.
Aspect 22: The method of any of Aspects 20-21, wherein the uplink resource is a dynamically-scheduled uplink resource or a UE-specific statically-scheduled uplink resource associated with at least one of: a cell-specific offset parameter, a UE-specific offset parameter, or any combination thereof.
Aspect 23: The method of any of Aspects 20-22, wherein the signaling includes an indication of a reserved time associated with at least one of a coverage area of a cell, a location of the UE within a cell, a timing advance parameter of the UE, or any combination thereof.
Aspect 24: The method of any of Aspects 20-23, wherein the timing configuration is conveyed via at least one of: a system information block, a medium access control (MAC) control element (CE), a radio resource control (RRC) message, or any combination thereof.
Aspect 25: The method of any of Aspects 20-24, wherein communicating with the UE comprises: transmitting a synchronization signal block transmission in the downlink resource, or receiving an uplink communication in the uplink resource.
Aspect 26: The method of any of Aspects 20-25, wherein the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.
Aspect 27: The method of any of Aspects 20-26, wherein the collision avoidance rule or the collision handling rule is associated with a reserved time for a downlink resource of a synchronization signal block, the reserved time not being counted for the uplink resource.
Aspect 28: The method of any of Aspects 20-27, wherein the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.
Aspect 29: The method of any of Aspects 20-28, wherein the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.
Aspect 30: The method of any of Aspects 20-29, wherein the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.
Aspect 31: The method of any of Aspects 20-30, wherein the collision avoidance rule or the collision handling rule is associated with a reserved time corresponding to a downlink resource with a configured grant or a dynamic grant, the reserved time not being counted for the uplink resource with the configured grant or the dynamic grant.
Aspect 32: The method of any of Aspects 20-31, wherein the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.
Aspect 33: The method of any of Aspects 20-32, wherein the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.
Aspect 34: The method of any of Aspects 20-33, wherein the collision handling rule is associated with a prioritization of downlink control channel monitoring of the downlink resource relative to an uplink resource with a configured grant if overlapping at least one symbol during a reserved time associated with downlink control channel monitoring of the downlink resource.
Aspect 35: The method of any of Aspects 20-34, wherein the collision avoidance rule or the collision handling rule is associated with a reserved time corresponding to downlink control channel monitoring of the downlink resource, and wherein the reserved time is not counted for the uplink resource with a configured grant.
Aspect 36: The method of any of Aspects 20-35, wherein the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.
Aspect 37: The method of any of Aspects 20-36, wherein the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.
Aspect 38: The method of any of Aspects 20-37, wherein the collision avoidance rule or the collision handling rule is based at least in part on whether a timing advance is estimated in connection with a UE reported timing advance or location.
Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.
Aspect 40: An apparatus for wireless communication at a device, the apparatus comprising one or more memories and one or more processors coupled to the one or more memories, the one or more processors configured to cause the device to perform the method of one or more of Aspects 1-38.
Aspect 41: An apparatus for wireless communication, the apparatus comprising at least one means for performing the method of one or more of Aspects 1-38.
Aspect 42: A non-transitory computer-readable medium storing code for wireless communication, the code comprising instructions executable by one or more processors to perform the method of one or more of Aspects 1-38.
Aspect 43: A non-transitory computer-readable medium storing a set of instructions for wireless communication, the set of instructions comprising one or more instructions that, when executed by one or more processors of a device, cause the device to perform the method of one or more of Aspects 1-38.
Aspect 44: A device for wireless communication, the device comprising a processing system that includes one or more processors and one or more memories coupled with the one or more processors, the processing system configured to cause the device to perform the method of one or more of Aspects 1-38
Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of' a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, for half-duplex operation in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
communicate, in the non-terrestrial network, with a network node using at least one of the uplink resource or the downlink resource in accordance with the collision avoidance rule or the collision handling rule.

2. The UE of claim 1, wherein the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.

3. The UE of claim 1, wherein the collision avoidance rule or the collision handling rule is associated with a reserved time for a downlink resource of a synchronization signal block, the reserved time not being counted for the uplink resource.

4. The UE of claim 1, wherein the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.

5. The UE of claim 1, wherein the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.

6. The UE of claim 1, wherein the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.

7. The UE of claim 1, wherein the collision avoidance rule or the collision handling rule is associated with a reserved time corresponding to a downlink resource with a configured grant or a dynamic grant, the reserved time not being counted for the uplink resource with the configured grant or the dynamic grant.

8. The UE of claim 1, wherein the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.

9. The UE of claim 1, wherein the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.

10. The UE of claim 1, wherein the collision avoidance rule or the collision handling rule is associated with a prioritization of downlink control channel monitoring of the downlink resource relative to an uplink resource with a configured grant if overlapping at least one symbol during a reserved time associated with downlink control channel monitoring of the downlink resource.

11. The UE of claim 1, wherein the collision avoidance rule or the collision handling rule is associated with a reserved time corresponding to downlink control channel monitoring of the downlink resource, and wherein the reserved time is not counted for the uplink resource with a configured grant.

12. The UE of claim 1, wherein the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.

13. The UE of claim 1, wherein the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.

14. The UE of claim 1, wherein the collision avoidance rule or the collision handling rule is based at least in part on whether a timing advance is estimated in connection with a UE reported timing advance or location.

15. A network node for wireless communication, comprising:
one or more memories; and
one or more processors, coupled to the one or more memories, configured to cause the network node to:
transmit, for half-duplex operation by a user equipment (UE) in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
communicate, in the non-terrestrial network, with the UE using at least one of the uplink resource or the downlink resource in accordance with the collision avoidance rule or the collision handling rule.

16. The network node of claim 15, wherein the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.

17. The network node of claim 15, wherein the collision avoidance rule or the collision handling rule is associated with a reserved time for a downlink resource of a synchronization signal block, the reserved time not being counted for the uplink resource.

18. The network node of claim 15, wherein the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.

19. The network node of claim 15, wherein the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.

20. The network node of claim 15, wherein the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.

21. The network node of claim 15, wherein the collision avoidance rule or the collision handling rule is associated with a reserved time corresponding to a downlink resource with a configured grant or a dynamic grant, the reserved time not being counted for the uplink resource with the configured grant or the dynamic grant.

22. The network node of claim 15, wherein the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.

23. The network node of claim 15, wherein the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.

24. The network node of claim 15, wherein the collision avoidance rule or the collision handling rule is associated with a prioritization of downlink control channel monitoring of the downlink resource relative to an uplink resource with a configured grant if overlapping at least one symbol during a reserved time associated with downlink control channel monitoring of the downlink resource.

25. The network node of claim 15, wherein the collision avoidance rule or the collision handling rule is associated with a reserved time corresponding to downlink control channel monitoring of the downlink resource, and wherein the reserved time is not counted for the uplink resource with a configured grant.

26. The network node of claim 15, wherein the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.

27. The network node of claim 15, wherein the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.

28. The network node of claim 15, wherein the collision avoidance rule or the collision handling rule is based at least in part on whether a timing advance is estimated in connection with a UE reported timing advance or location.

29. A method of wireless communication performed by a user equipment (UE), comprising:
receiving, for half-duplex operation in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
communicating, in the non-terrestrial network, with a network node using at least one of the uplink resource or the downlink resource in accordance with the collision avoidance rule or the collision handling rule.

30. The method of claim 29, wherein the uplink resource is a non-UE-specific, dynamically-scheduled uplink resource associated with the offset parameter, and wherein the offset parameter is a cell-specific offset parameter.

31. The method of claim 29, wherein the uplink resource is a dynamically-scheduled uplink resource or a UE-specific statically-scheduled uplink resource associated with the offset parameter, and wherein the offset parameter is at least one of: a cell-specific offset parameter, a UE-specific offset parameter, or any combination thereof.

32. The method of claim 29, wherein the signaling includes an indication of a reserved time associated with at least one of a coverage area of a cell, a location of the UE within the cell, a timing advance parameter of the UE, or any combination thereof.

33. The method of claim 29, wherein the timing configuration is conveyed via at least one of:
a system information block,
a medium access control (MAC) control element (CE),
a radio resource control (RRC) message, or
any combination thereof.

34. The method of claim 29, wherein communicating with the network node comprises:
receiving a synchronization signal block transmission in the downlink resource, or
transmitting an uplink communication in the uplink resource.

35. The method of claim 29, wherein the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.

36. The method of claim 29, wherein the collision avoidance rule or the collision handling rule is associated with a reserved time for a downlink resource of a synchronization signal block, the reserved time not being counted for the uplink resource.

37. The method of claim 29, wherein the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.

38. The method of claim 29, wherein the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.

39. The method of claim 29, wherein the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.

40. The method of claim 29, wherein the collision avoidance rule or the collision handling rule is associated with a reserved time corresponding to a downlink resource with a configured grant or a dynamic grant, the reserved time not being counted for the uplink resource with the configured grant or the dynamic grant.

41. The method of claim 29, wherein the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.

42. The method of claim 29, wherein the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.

43. The method of claim 29, wherein the collision avoidance rule or the collision handling rule is associated with a prioritization of downlink control channel monitoring of the downlink resource relative to an uplink resource with a configured grant if overlapping at least one symbol during a reserved time associated with downlink control channel monitoring of the downlink resource.

44. The method of claim 29, wherein the collision avoidance rule or the collision handling rule is associated with a reserved time corresponding to downlink control channel monitoring of the downlink resource, and wherein the reserved time is not counted for the uplink resource with a configured grant.

45. The method of claim 29, wherein the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.

46. The method of claim 29, wherein the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.

47. The method of claim 29, wherein the collision avoidance rule or the collision handling rule is based at least in part on whether a timing advance is estimated in connection with a UE reported timing advance or location.

48. A method of wireless communication performed by a network node, comprising:
transmitting, for half-duplex operation by a user equipment (UE) in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
communicating, in the non-terrestrial network, with the UE using at least one of the uplink resource or the downlink resource in accordance with the collision avoidance rule or the collision handling rule.

49. The method of claim 48, wherein the uplink resource is a non-UE-specific, dynamically-scheduled uplink resource associated with the offset parameter, wherein the offset parameter is a cell-specific offset parameter.

50. The method of claim 48, wherein the uplink resource is a dynamically-scheduled uplink resource or a UE-specific statically-scheduled uplink resource associated with the offset parameter, wherein the offset parameter is at least one of: a cell-specific offset parameter, a UE-specific offset parameter, or any combination thereof.

51. The method of claim 48, wherein the signaling includes an indication of a reserved time associated with at least one of a coverage area of a cell, a location of the UE within the cell, a timing advance parameter of the UE, or any combination thereof.

52. The method of claim 48, wherein the timing configuration is conveyed via at least one of:
a system information block,
a medium access control (MAC) control element (CE),
a radio resource control (RRC) message, or
any combination thereof.

53. The method of claim 48, wherein communicating with the UE comprises:
transmitting a synchronization signal block transmission in the downlink resource, or
receiving an uplink communication in the uplink resource.

54. The method of claim 48, wherein the collision avoidance rule or the collision handling rule is associated with a prioritization of a synchronization signal block in the downlink resource relative to an uplink transmission in at least part of the uplink resource, wherein an overlap is configured to occur in at least one symbol during a reserved time associated with the downlink resource of the synchronization signal block.

55. The method of claim 48, wherein the collision avoidance rule or the collision handling rule is associated with a reserved time for a downlink resource of a synchronization signal block, the reserved time not being counted for the uplink resource.

56. The method of claim 48, wherein the collision avoidance rule or the collision handling rule is associated with a prioritization of a synchronization signal block in the downlink resource relative to at least part of the uplink resource, wherein an overlap is configured to occur in at least one symbol or is configured to occur during a switching time in an absence of signaling indicating a reserved time.

57. The method of claim 48, wherein the collision avoidance rule or the collision handling rule is associated with a prioritization of the uplink resource relative to at least part of the downlink resource of a synchronization signal block, wherein an overlap is configured to occur in at least one symbol or during a switching time in an absence of the signaling indicating a reserved time.

58. The method of claim 48, wherein the collision avoidance rule or the collision handling rule is associated with a prioritization of a downlink resource with a configured grant or a dynamic grant relative to at least part of the uplink resource with a configured grant or a dynamic grant, wherein an overlap is configured to occur in at least one symbol during a reserved time associated with the downlink resource with the configured grant or the dynamic grant.

59. The method of claim 48, wherein the collision avoidance rule or the collision handling rule is associated with a reserved time corresponding to a downlink resource with a configured grant or a dynamic grant, the reserved time not being counted for the uplink resource with the configured grant or the dynamic grant.

60. The method of claim 48, wherein the collision avoidance rule or the collision handling rule is associated with a prioritization of a downlink resource with a configured grant, a dynamic grant relative to at least part of the uplink resource with a configured grant, or a dynamic grant that overlaps with at least one symbol, wherein the prioritization is related to a switching time in an absence of signaling indicating a reserved time.

61. The method of claim 48, wherein the collision avoidance rule or the collision handling rule is associated with a prioritization of the uplink resource with a configured grant or a dynamic grant relative to at least part of a downlink resource with a configured grant or a dynamic grant, wherein the prioritization is related to an overlap of at least one symbol or is related to a switching time in an absence of signaling indicating a reserved time.

62. The method of claim 48, wherein the collision handling rule is associated with a prioritization of downlink control channel monitoring of the downlink resource relative to an uplink resource with a configured grant if overlapping at least one symbol during a reserved time associated with downlink control channel monitoring of the downlink resource.

63. The method of claim 48, wherein the collision avoidance rule or the collision handling rule is associated with a reserved time corresponding to downlink control channel monitoring of the downlink resource, and wherein the reserved time is not counted for the uplink resource with a configured grant.

64. The method of claim 48, wherein the collision avoidance rule or the collision handling rule is associated with a prioritization of downlink control channel monitoring of the downlink resource relative to at least part of the uplink resource with a configured grant, wherein an overlap is configured in at least one symbol or during a switching time in an absence of signaling indicating a reserved time.

65. The method of claim 48, wherein the collision avoidance rule or the collision handling rule is associated with a prioritization of an uplink resource with a configured grant relative to at least part of a downlink control channel monitoring of the downlink resource, wherein an overlap is configured in at least one symbol or during a switching time in an absence of signaling indicating a reserved time.

66. The method of claim 48, wherein the collision avoidance rule or the collision handling rule is based at least in part on whether a timing advance is estimated in connection with a UE reported timing advance or location.

67. A non-transitory computer-readable medium storing a set of instructions for wireless communication, the set of instructions comprising:
one or more instructions that, when executed by one or more processors of a user equipment (UE), cause the UE to:
receive, for half-duplex operation in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
communicate, in the non-terrestrial network, with a network node using at least one of the uplink resource or the downlink resource in accordance with the collision avoidance rule or the collision handling rule.

68. A non-transitory computer-readable medium storing a set of instructions for wireless communication, the set of instructions comprising:
one or more instructions that, when executed by one or more processors of a network node, cause the network node to:
transmit, for half-duplex operation by a user equipment (UE) in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
communicate, in the non-terrestrial network, with the UE using at least one of the uplink resource or the downlink resource in accordance with the collision avoidance rule or the collision handling rule.

69. An apparatus for wireless communication, comprising:
means for receiving, for half-duplex operation in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
means for communicating, in the non-terrestrial network, with a network node using at least one of the uplink resource or the downlink resource in accordance with the collision avoidance rule or the collision handling rule.

70. An apparatus for wireless communication, comprising:
means for transmitting, for half-duplex operation by a user equipment (UE) in a non-terrestrial network, signaling identifying a timing configuration, wherein the timing configuration is related to a collision avoidance rule or a collision handling rule,
wherein the collision avoidance rule or the collision handling rule is related to an overlapping between a downlink resource and an uplink resource associated with an offset parameter; and
means for communicating, in the non-terrestrial network, with the UE using at least one of the uplink resource or the downlink resource in accordance with the collision avoidance rule or the collision handling rule.
